(19) United States
(12) Patent Application Publication
(10) Pub. No.: US 2006/0284343 A1
(43) Pub. Date: Dec. 21, 2006

(54) RTM auto-vent process

(75) Inventors: Paul Arthur Trudeau, Bolton (CA); Lassi M. Ojanen, Richmond Hill (CA); David Denis Rouison, Brampton (CA); Jonathan Mark Mills, Toronto (CA)

Correspondence Address: WARN, HOFFMANN, MILLER & LALONE, .P.C, PO BOX 70098, ROCHESTER HILLS, MI, 48307, US

(73) Assignee: Magna International Inc., Aurora (CA)

(21) Appl. No.: 11/455,998

(22) Filed: Jun. 20, 2006

Related U.S. Application Data
(60) Provisional application No. 60/692,311, filed on Jun. 20, 2005.

(51) Int. Cl. B29C 45/00

(52) U.S. Cl. 264/328.1; 264/328.12; 425/542; 249/141

(57) ABSTRACT

A resin transfer system having an automatic vent system operably associated therewith is provided. The automatic vent system is operable to selectively engage once a predetermined amount of mouldable material has been introduced into the resin transfer system. The automatic vent system can also selectively remove or purge any excess materials, such as excess resin, from the resin transfer system, without having to manually clean any conduits or catch pots.

### CROSS-REFERENCE TO RELATED APPLICATIONS

This application claims the benefit of U.S. Provisional Application No. 60/692,311, filed Jun. 20, 2005. The disclosures of the above applications are incorporated herein by reference.

### FIELD OF THE INVENTION

The present invention relates generally to resin transfer moulding, and more specifically to a resin transfer moulding system having an automatic venting system.

### BACKGROUND OF THE INVENTION

Resin transfer moulding (“RTM”) is generally known as a low pressure, closed moulding process that offers a dimensionally accurate and high quality surface finish composite moulding, using liquid thermoset polymers reinforced with various forms of fiber reinforcements. Typically, polymers of various epoxy, vinyl ester, methyl methacrylate, polyester, polyurethanes, polyester/urethane blends, and/or phenolic materials are used with various reinforcement materials, such as fiberglass. Other reinforcement materials, such as aramids, carbon fibers, and/or synthetic fibers, either alone or in combination with each other, can be used for more demanding applications. Along with the polymer and reinforcement materials, the addition of mineral fillers may be added to enhance fire retardancy, flex modulus and surface finish.

Reinforcements are typically presented in their dry form to the mould in either binder-bound chopped mat, random-continuous strand mat, and/or woven cloth format. The fiber has been either “preformed” to the exact shape of the moulding tool in a previous operation or is hand-tailored during the loading process in the moulding tool. After the fiber is installed into the mould, a premixed catalyst/hardener and resin is injected into the closed mould cavity encapsulating the fiber within. The primary surface of the moulding may be gel-coated or in-mould primed, a process of spraying the mould surface before installing the fiber. If a gel coat is not required, the exterior finish would be the same from the front to back of the moulded part.

The RTM process has the inherent advantage of low-pressure injection, i.e., it usually does not exceed 300 psi of resin injection pressure during the mould-fill process.

Current vacuum-assisted RTM processes typically involve filling the mould cavity under partial vacuum. For example, resin enters the part through a perimeter gate and it typically converges at a vent location often centrally located with respect to the part. Resin then overflows into a catch pot, which is used to prevent resin from entering the vacuum system. After the liquid resin cures, the vacuum is removed and the catch pot is removed and emptied manually. For polyester and vinyl ester resins, the level of vacuum is typically kept below the boiling point of styrene, around 24 in. Hg.

Several problems can arise with conventional approaches. First, partial vacuum contributes to air in the part, thus resulting in porosity and other imperfections in the finished part. Second, manual effort is required to clean the catchpot, thus the system cannot be automated which increases cycle time as well as manufacturing costs. Third, resin is wasted in the overflow pot, again increasing manufacturing costs. Fourth, pressure cannot be applied in the cavity to drive porosity as the system is always open to the vacuum system until the resin gelation process has occurred.

Accordingly, there exists a need for a new and improved resin transfer moulding system.

### SUMMARY OF THE INVENTION

It is an object of the present invention to provide a new and improved resin transfer moulding system which obviates at least one disadvantage of the prior art.

It is another object of the present invention to provide new and improved resin transfer moulding systems that include automatic vent systems operably associated therewith

In accordance with the general teachings of the present invention a resin transfer system is provided with an automatic vent system that closes when all the predetermined resin material (as well as the catalyst/hardener and any other additives) has been injected in the mould cavity that is used to form the finished part. A substantially cylindrical column connected to the automatic vent system is also connected to a valve system, e.g., a three-way valve, which is connected to the full vacuum source on one side and to the flushing/purging system on the other side. When the automatic vent system closes, in parallel the valve system switches from vacuum to flush/purge. This allows, for example, resin and/or styrene in the column to be flushed/purged and thus prevents freezing lines in the system. The automatic vent system in the mould also includes a valve system e.g., a three way valve, which when open acts as the vent and vacuum source, and when closed, the valve is open to flush/purge.

In accordance with a first embodiment of the present invention, a resin transfer system having an automatic vent system operably associated therewith is provided.

In accordance with a second embodiment of the present invention, a resin transfer system having an automatic vent system operably associated therewith is provided, wherein the automatic vent system is operable to selectively engage once a predetermined amount of mouldable material has been introduced into the resin transfer system.

In accordance with a third embodiment of the present invention, a resin transfer system having an automatic vent system operably associated therewith is provided, wherein the automatic vent system is operable to selectively remove any excess material contained within the resin transfer system after a predetermined amount of mouldable material has been introduced into the resin transfer system.

In accordance with a fourth embodiment of the present invention, a resin transfer system having an automatic vent system operably associated therewith is provided, wherein the automatic vent system is operable to selectively permit a vacuum force to be applied to the resin transfer system.

In accordance with a fifth embodiment of the present invention, a resin transfer system having an automatic vent system operably associated therewith is provided, wherein the automatic vent system is operable to selectively prevent a vacuum force being applied to the resin transfer system.

In accordance with a sixth embodiment of the present invention, a resin transfer system is provided, wherein the resin transfer system includes a selectively inflatable seal system operably associated with a moulding system.

In accordance with a seventh embodiment of the present invention, a resin transfer system is provided, wherein the resin transfer system includes a selectively inflatable seal system and a selectively operable hydraulic system, both of which are operably associated with a moulding system.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates a partial perspective view of a resin transfer moulding system prior to injection of any of the components, in accordance with the general teachings of the present invention;

FIG. 2 illustrates a partial perspective view of a resin transfer moulding system at the conclusion of the injection of the components, in accordance with the general teachings of the present invention;

FIG. 3 illustrates a partial schematic view of a resin transfer moulding system at the conclusion of the injection of the components, in accordance with the general teachings of the present invention;

FIG. 4 illustrates a partial schematic view of a resin transfer moulding system when the flushing/purging system is engaged, in accordance with the general teachings of the present invention;

FIG. 5 illustrates a partial perspective view of a resin transfer moulding system when the hydraulic clamp is engaged, in accordance with the general teachings of the present invention;

FIG. 6 illustrates a partial schematic view of a resin transfer moulding system when the hydraulic clamp is engaged, in accordance with the general teachings of the present invention;

FIG. 7 illustrates a partial perspective view of a resin transfer moulding system during the exothermic and shrinkage of the polymer phases, in accordance with the general teachings of the present invention;

FIG. 8 illustrates a partial perspective view of a resin transfer moulding system during the optional expansion of the low profile fillers phase, in accordance with the general teachings of the present invention; and

FIG. 9 illustrates a partial perspective view of a resin transfer moulding system during the de-moulding phase, in accordance with the general teachings of the present invention.

### DETAILED DESCRIPTION OF THE PREFERRED EMBODIMENTS

The following description of the preferred embodiment(s) is merely exemplary in nature and is in no way intended to limit the invention, its application, or uses.

Although the present invention is primarily intended for use with RTM systems, it should be appreciated that the present invention can be practiced with other types of moulding processes, such as but not limited to structural reinforcement moulding (i.e., SRIM) processes.

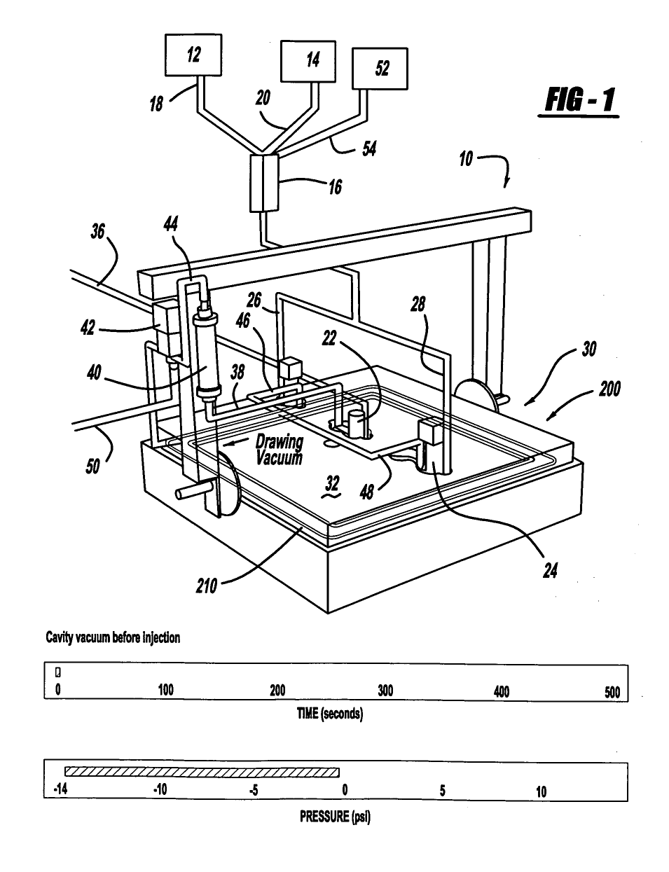

Referring to the Figures generally, and specifically to FIG. 1, there is shown a resin transfer system generally at 10. System 10 can be employed to produce any number of different finished parts, such as but not limited to automotive components and the like. By way of a non-limiting example, system 10 can employ liquid thermoset polymers reinforced with various forms of fiber reinforcements to produce these products. For example, system 10 can employ polymers of various epoxy, vinyl ester, methyl methacrylate, polyester, and/or phenolic materials are used with various reinforcement materials, such as fiberglass. Other reinforcement materials, such as aramids, carbon fibers, and/or synthetic fibers, either alone or in combination with each other, can be used for more demanding applications, in accordance with the general teachings of the present invention.

System 10 includes a resin source 12 and a catalyst/hardener source 14 that are used to form a finished moulded part. Sources 12, 14, respectively, are in communication with a mixer 16 (e.g., static or dynamic) through conduits 18, 20, respectively. Mixer 16 is in communication with a pair of injection heads 22, 24, respectively, through conduits 26, 28, respectively. Injection heads 22, 24, respectively, are in communication with the mould 30, and more specifically, with the mould cavity 32, e.g., for permitting the introduction of the resin and catalyst/hardener therein. An automatic vent system 34 is in communication with the mould 30, and more specifically, with the mould cavity 32. Exiting from one portion of automatic vent system 34 is a purge conduit 36. Exiting from another portion of automatic vent system 34 is a conduit 38 which is in communication with a resin overflow system 40. Resin overflow system 40 is in communication with a vacuum vent/resin purge system 42 via conduit 44. Injection heads 22, 24, respectively, are also in communication with vacuum vent/resin purge system 42 via conduits 46, 48, respectively. A vent conduit 50 exits from a portion of vacuum vent/resin purge system 42. A purge system 52 (e.g., employing acetone and/or air) is in communication with mixer 16 via conduit 54.

As can be seen in FIG. 1, system 10 is shown at the point where injection of any materials into mould cavity 32 has not yet occurred, i.e., 0 time has elapsed in the moulding process. However, the pressure in system 10 is maintained at about −14 psi, i.e., system 10 is maintained under vacuum or negative pressure.

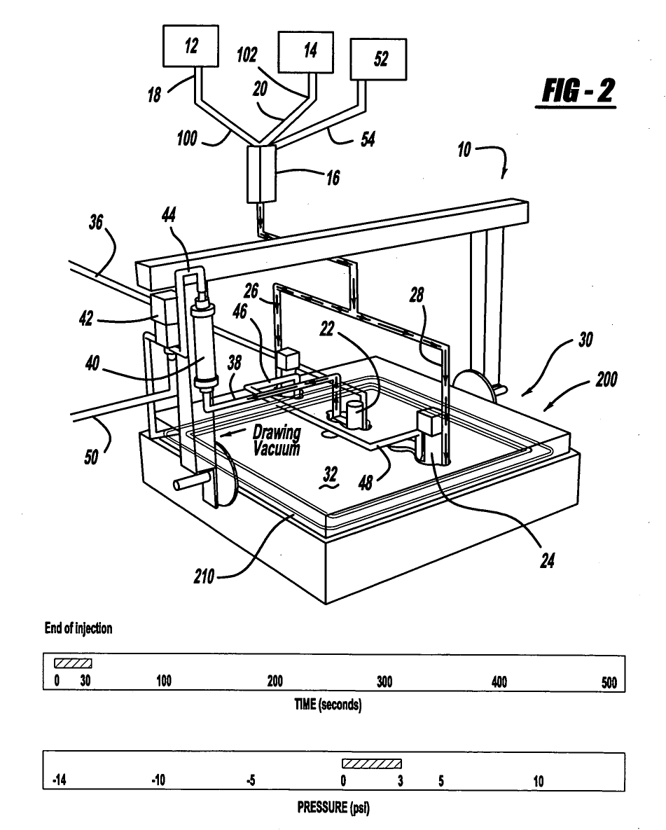

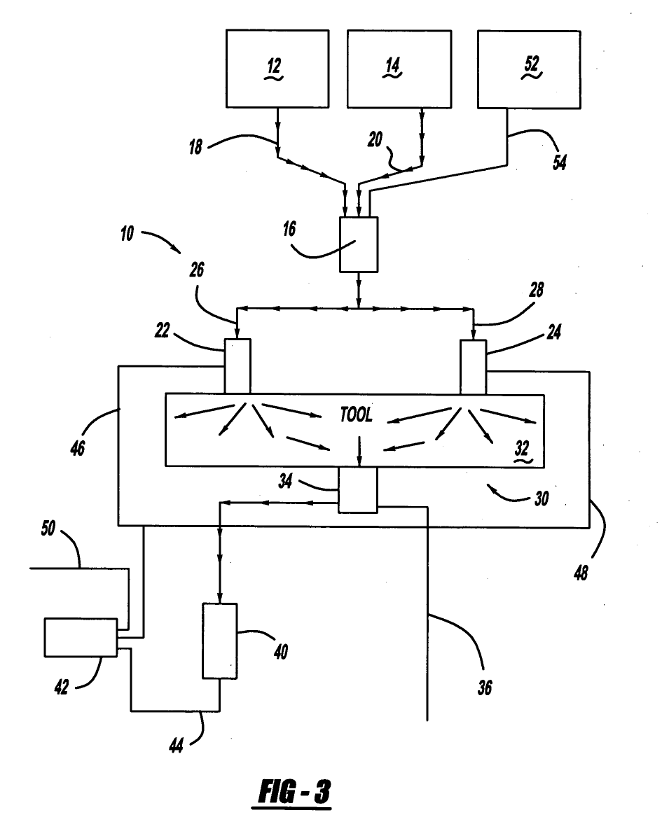

Referring to FIGS. 2 and 3, the resin material 100 and the catalyst/hardener material 102 are selectively injected into system 10 via their respective sources, 12, 14. The path of the materials, 100, 102, can be tracked through system 10 by following the arrow paths.

As can be seen in FIG. 2, system 10 is shown at the point where injection of any materials into mould cavity 32 has just finished occurred, i.e., 30 seconds have elapsed in the moulding process. However, the pressure in mould cavity 32 is maintained at about 3 psi, i.e., mould cavity 32 is maintained under positive pressure.

In accordance with one aspect of the present invention, automatic vent system 34 is selectively operable to close when all of the predetermined resin material (as well as any catalyst/hardener and other additives) to form the finished part has been injected into mould cavity 32. In this view, any excess material, such as excess resin material 100 or the like, is traveling towards resin overflow system 40.

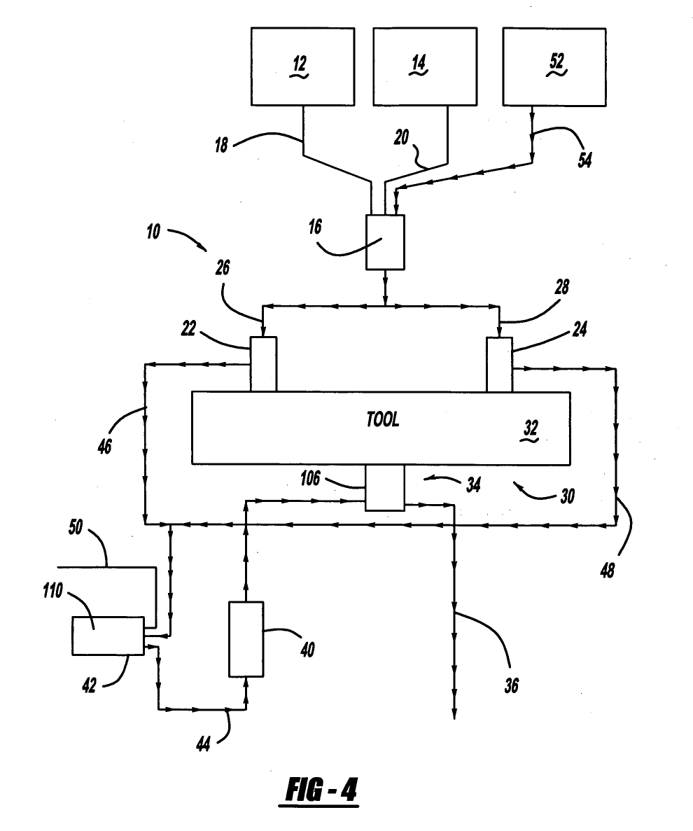

Automatic vent system 34 includes a valve system 104 operably associated therewith. Valve system 104 can include, but is not limited to a three-way valve system 106. Referring to FIG. 4, when automatic vent system 34 closes, in parallel this three way valve system 106 switches from vacuum operation to flush operation. Resin overflow system 40, which is communication with automatic vent system 34 is also in communication with vent/resin purge system 42. Vacuum vent/resin purge system 42 also includes a valve system 108. Valve system 108 can include, but is not limited to a three-way valve system 110. Valve system 108 selectively controls the vacuum operation and the purging operation of vacuum vent/resin purge system 42.

By permitting automatic vent system 34 to actuate its purging operation, any excess or residual resin, styrene and/or other materials in resin overflow system 40 or other portions of system 10 (e.g., various conduits, chambers, and/or the like) can be purged, thus preventing freezing lines in system 10. It should be noted that the purging operation can be performed at any time during the moulding process after the requisite amount of mouldable material (e.g., resin, catalyst, hardener, additives and the like) has been introduced into mould cavity 32 and preferably before the mouldable material substantially begins to gel and/or cure.

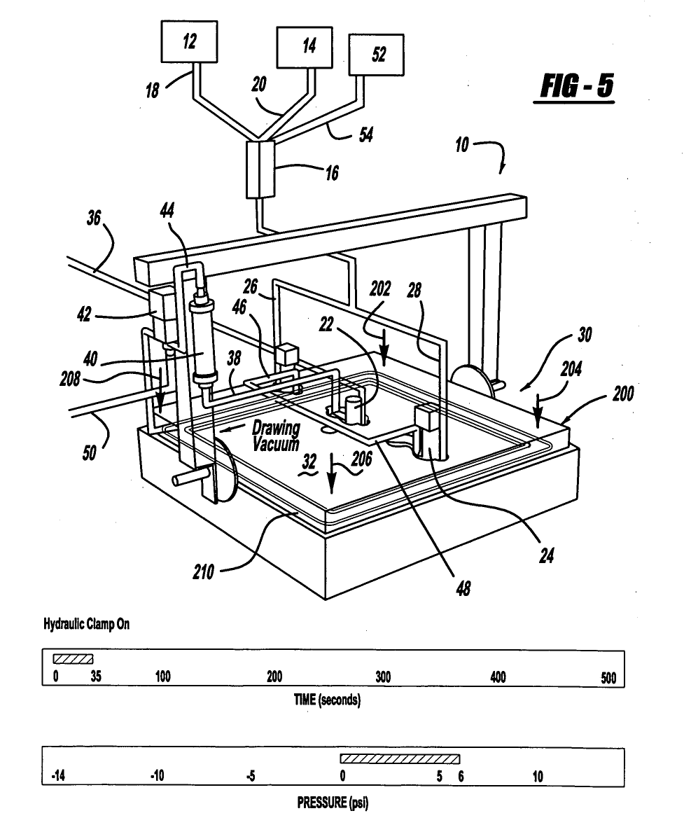

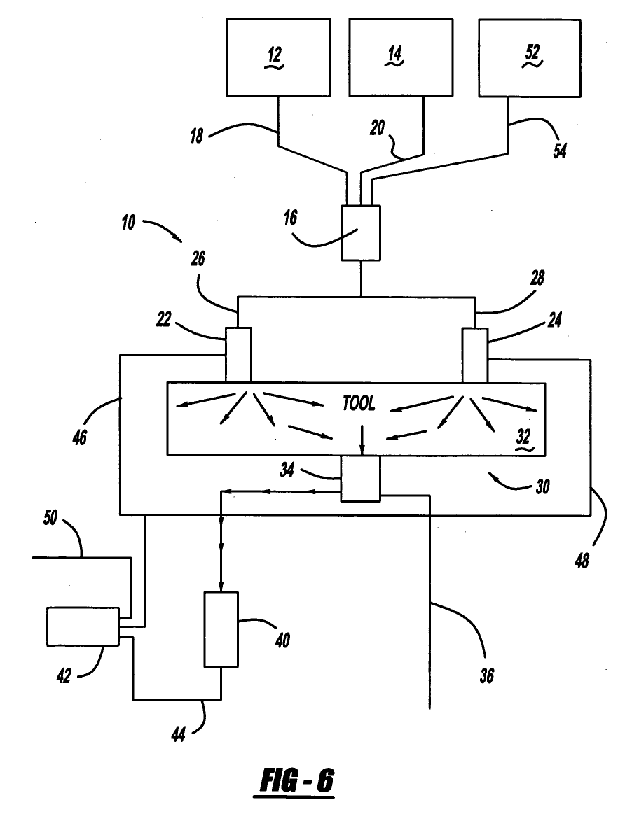

Referring to FIGS. 5 and 6, system 10 is shown wherein a hydraulic clamping system 200, consisting of a series of hydraulic clamps 202, 204, 206, 208, respectively, are shown in the engaged position so as to compress the mouldable material contained within mould cavity 32. As can be seen in FIG. 5, system 10 is shown at the point where injection of any materials into mould cavity 32 has already occurred, i.e., 35 seconds have elapsed in the moulding process. However, the pressure in mould cavity 32 is maintained at about 6 psi, i.e., mould cavity 32 is maintained under positive pressure.

In accordance with another aspect of the present invention, a selectively inflatable inner perimeter seal system 210 is employed to gap the tool or mould cavity slightly. For example, at a predetermined time, hydraulic clamping system 200 will close the mould cavity 32 to a fixed thickness. This will provide significant processing advantages for wetting out any fiber systems contained therein that typically exhibit poor permeability, as well as providing advantages in terms of speeding up injection times. Further, the surface quality of the finished part will also be enhanced due to an increase in pressure seen in the tool or mould cavity at the end of the filling cycle.

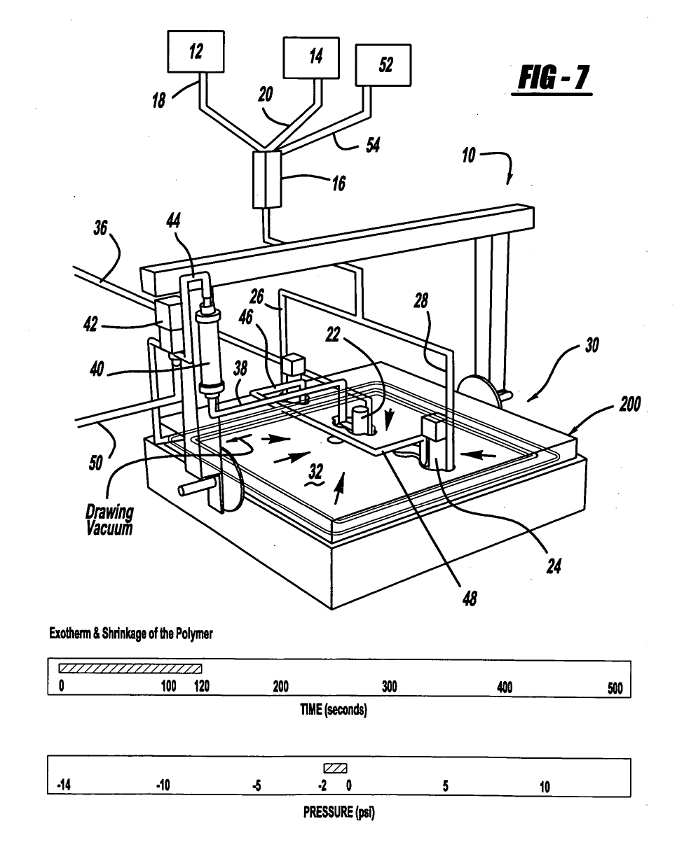

Referring to FIG. 7, system 10 is shown during the exothermic and shrinkage of the polymer phases of the moulding process. As can be seen in FIG. 7, system 10 is shown at the point where the mouldable materials are reacting with one another and beginning to form the part, i.e., 120 seconds have elapsed in the moulding process. However, the pressure in mould cavity 32 is maintained at about −2 psi, i.e., mould cavity 32 is maintained under negative pressure.

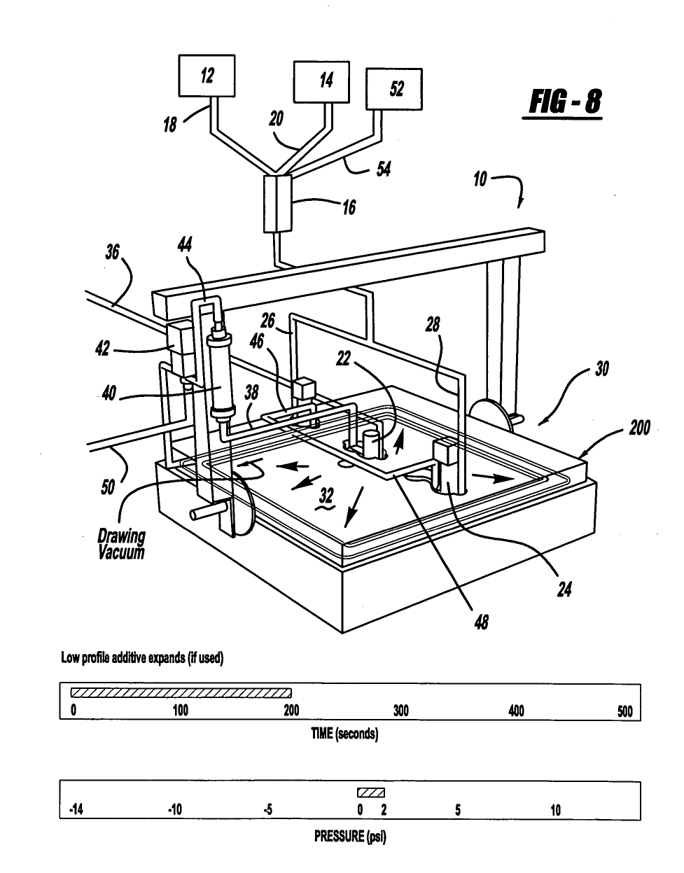

Referring to FIG. 8, system 10 is shown during the expansion of the optional low profile additives phase of the moulding process. As can be seen in FIG. 8, system 10 is shown at the point where any additives that cause expansion are causing the injected mouldable materials to expand, i.e., 200 seconds have elapsed in the moulding process. However, the pressure in mould cavity 32 is maintained at about 2 psi, i.e., mould cavity 32 is maintained under positive pressure.

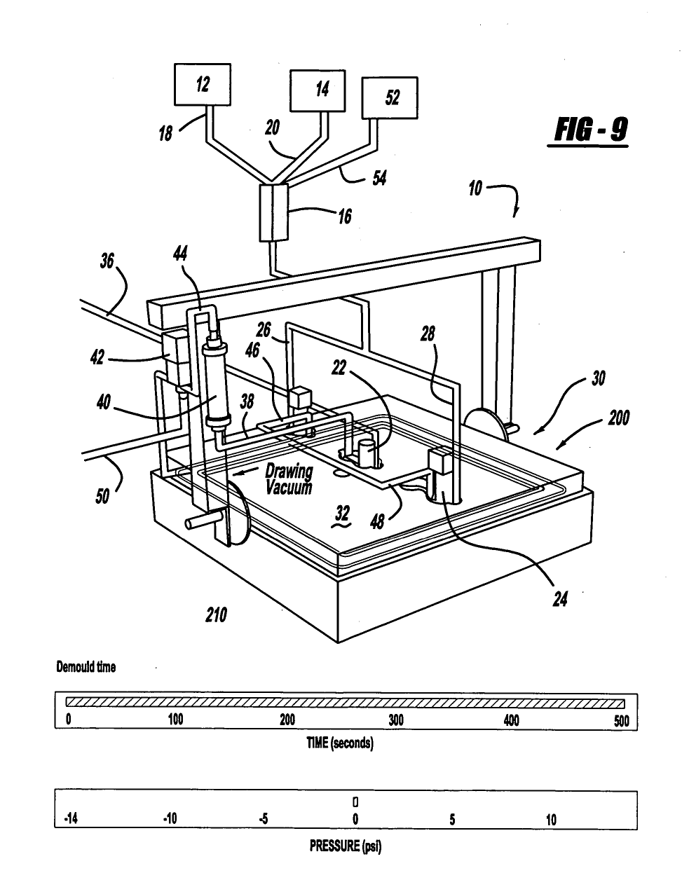

Referring to FIG. 9, system 10 is shown during the de-moulding phase of the moulding process. As can be seen in FIG. 9, system 10 is shown at the point where the part is in the process of fully gelling or curing, i.e., 500 seconds have elapsed in the moulding process. However, the pressure in mould cavity 32 is maintained at about 0 psi.

It should be appreciated that the aforementioned discussion of pressure levels and time periods are illustrative in nature and can be modified within the scope of the present invention. For example, certain mouldable materials may require longer or shorter moulding times as well as require more than or less than the pressures depicted in any of the Figs. or the described in the discussion contained herein.

There are several advantages associated with the system of the present invention, such as but not limited to: (1) the ability to employ relatively high levels of vacuum in the mould cavity without the negative effects of the boiling styrene, which could result in reduced air in the system and reduced porosity in the finished part. Furthermore, when full vacuum in the mould cavity is used, e.g., when filling, only the leading front of the resin material boils, with the vapour and resin exiting the mould cavity and is kept from entering the vacuum system by entering resin overflow system that has a screen to wick away the vapours. When the pumping stops, the automatic vent system (specifically the valve system operably associated therewith) closes, cutting off the vacuum from the mould cavity. This traps the resin material in the mould cavity and allows the user to introduce pressure if required. The resin material and vapor that get past the valve system are flushed to waste using a purge system, such as but not limited to an acetone and/or air purge system; (2) the system can be easily automated (e.g., via computer controls) and thus no manual cleaning operations would be required; (3) there is less wasted resin in that the user does not need to overfill the system, e.g., due in part to the relatively high initial vacuum levels; (4) fill times are relatively faster at the relatively higher vacuum levels; (5) by coordinating when the automatic vent system closes, the user can introduce positive pressure into the mould cavity which could improve the overall cosmetic appearance of the finished part.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A mould device comprising:
a mould tool;
at least one injection head connected to said mould tool for introducing resin material into said mould tool; and
an automatic vent system operably connected to said mould tool and said at least one injection head, wherein said automatic vent system vents and purges resin material from said mould tool and said at least one injection head.

2. The moulding device of claim 1 wherein said automatic vent system has a valve operably connected to said mould tool and a purge conduit connected to said valve.

3. The mould device of claim 2 wherein said valve is a three way valve.

4. The moulding device of claim 2 further comprising a resin overflow system connected to said valve.

5. The moulding device of claim 1 further comprising a vacuum vent resin purge valve operably connected to said automatic vent system and to said one or more injection heads.

6. The moulding device of claim 5 further comprising a purge system connected to said at least one injection head for purging said at least one injection head to said automatic vent system.

7. The moulding device of claim 5 further comprising a vent conduit connected to said vacuum vent resin purge valve.

8. The moulding device of claim 1 further comprising a dynamic mixer connected to said at least one injection head for mixing the resin and catalyst.

9. A mould device comprising:
a mould tool;
at least one injection head connected to said mould tool for introducing resin material to said mould tool;
a vacuum vent resin purge valve connected to said at least one injection head;
an automatic vent system connected to said mould tool and to said vacuum vent resin purge valve; and
a purge conduit connected to said automatic vent system.

10. The moulding device of claim 9 further comprising a vent conduit connected to said vacuum vent resin purge valve.

11. The moulding device of claim 9 further comprising a resin overflow system operatively connected between said automatic vent system and said vacuum vent resin purge valve.

12. The moulding device of claim 9 wherein said automatic vent system has a valve operably connected to said moulding tool and a purge conduit connected to said valve.

13. The mould device of claim 12 wherein said valve is a three way valve.

14. The moulding device of claim 12 further comprising a resin overflow system connected to said valve.

15. The moulding device of claim 9 further comprising a purge system connected to said at least one injection head for purging said at least one injection head to said automatic vent system.

16. The moulding device of claim 9 further comprising a dynamic mixer connected to said at least one injection head for mixing the resin and catalyst.

17. The method of purging and venting a moulding device providing a moulding tool, at least one injection head connected to said mould tool, a vacuum vent resin purge valve connected to said at least one injection head, an automatic vent system connected to said mould tool and to said vacuum vent resin purge valve and a purge conduit connected to said automatic vent system, further comprising the steps of:
injecting material into said mould tool;
removing excess material from said mould tool through said automatic vent system;
closing said automatic vent system once enough material has been introduced to said mould tool;
purging material from said at least one injection head through said vacuum vent resin purge valve; and
exhausting material from said step of purging material through said automatic vent system to a purge conduit.

18. The method of claim 17 further comprising the steps of:
providing a vent conduit connected to said vacuum vent resin purge valve;
venting air through said vent conduit prior to injection of material.

19. The method of claim 17 further comprising the steps of:
providing a dynamic mixer operably connected to said injection head;
providing a purge system connected to said dynamic mixer, wherein said purge system supplies a purge mixture to said dynamic mixer;
selectively flushing said purge mixture through said dynamic mixer and flushing said one or more injection heads.

20. The method of claim 19 further comprising the steps of:
flushing said purge mixture through said vacuum vent resin purge valve, said automatic vent system to an exit the end of said purge conduit.
